(19) United States
(12) Patent Application Publication
(10) Pub. No.: US 2026/0140762 A1
(43) Pub. Date: May 21, 2026

(54) HYBRID WORKFLOW TASK IMPLEMENTATION

(71) Applicant: Hewlett Packard Enterprise Development LP, Spring, TX (US)

(72) Inventors: Anderson Andrei Da Silva, Oakland, CA (US); Gourav Rattihalli, Milpitas, CA (US); Dejan S. Milojicic, Palo Alto, CA (US)

(21) Appl. No.: 18/949,757

(22) Filed: Nov. 15, 2024

(51) Int. Cl. G06F 9/48

(52) U.S. Cl. CPC G06F 9/4881

(57) ABSTRACT

Provided herein are techniques for workflow task assignment in a hybrid implementation environment having a plurality of different implementation environments with differing implementation benefits. A workflow of tasks is analyzed to identify a first subset of tasks to be implemented in a first one of the implementation environments and a second subset of tasks to be implemented in a second implementation environment. The first subset and second subset are determined based upon relevant characteristics of the implementation, such as characteristics of the workflow, tasks, and/or implementation environment(s).

### BACKGROUND

The present disclosure relates generally to workflow task implementation. More specifically, the present disclosure relates to a hybrid implementation of workflow tasks that identifies and assigns tasks to a particular one of a plurality of implementation environments.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

In high performance computing (HPC), workflows are a set of ordered and connected tasks or jobs, which may share data and results, to achieve the completion of a relatively larger overall task. Workflow tasks can be executed sequentially or in parallel.

A workflow manager is a tool that manages the execution of workflows. The workflow manager is responsible for guaranteeing the completion of all tasks in their respective orders to achieve the overall task.

A directed acyclic graph (DAG) is a data-structure used for representing workflows. In this context, tasks (or functions) can be described as nodes in a DAG, and their connection can be described using arrows in a DAG. Therefore, a connection between two nodes indicates that one function requires the other one, and the direction of the DAG's arrows represents the priority of the execution.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram, illustrating a system that provides hybrid workflow, in accordance with aspects of the present disclosure;

FIG. 2 is a flowchart, illustrating a process for identifying and assigning implementation environments for task implementation across a hybrid implementation environment, in accordance with aspects of the present disclosure;

FIG. 3 is a flowchart, illustrating a process for identifying and assigning implementation environments for task implementation across a hybrid implementation environment including an on-premises implementation environment and an off-premises implementation environment, in accordance with aspects of the present disclosure;

FIG. 4 is a schematic diagram, illustrating an example of assignment of tasks in a hybrid implementation environment, in accordance with aspects of the present disclosure;

FIG. 5 is a schematic diagram, illustrating another example assignment of tasks in a hybrid implementation environment, in accordance with aspects of the present disclosure;

FIG. 6 is a flowchart, illustrating a process for identifying and assigning implementation environments for task implementation across a hybrid implementation environment during workflow/job execution, in accordance with aspects of the present disclosure; and

FIG. 7 is a flowchart, illustrating a process for identifying and assigning implementation environments for task implementation, accounting for multiple running workflows/jobs within the hybrid implementation environment, in accordance with aspects of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

The present disclosure relates generally to hybrid workflow task implementation among a plurality of different implementation environments with differing implementation benefits, such as an on-premises implementation environment and an off-premises (e.g., cloud) environment. Specifically, a benchmark-driven scheduler may analyze a workflow of tasks to identify a first subset of tasks to be implemented on premises and a second subset of tasks to be implemented off-premises (e.g., in the cloud). The first subset and second subset are determined based upon characteristics of the tasks within the workflow. For example, tasks identified as having a relatively fine granularity, such as a task having an execution time under a particular threshold amount of time, and/or a task having multiple implemented instances may be identified as tasks that are suggested candidates for implementation via “serverless” functions in a cloud infrastructure. As used herein, “serverless” refers to a computational paradigm, where the size of the deployed programs is reduced to functions (for ease of deployment), and the management and execution process is performed by a platform provider, such as a cloud services provider. This paradigm facilitates the deployment of fast execution functions, making them more easily scalable and reducing costs on on-premises resource usage.

On an initial pass, the benchmark-driven scheduler may identify, such as from a directed acyclic graph (DAG), task (e.g., nodes of the DAG) characteristics that indicate whether the tasks should be implemented on premises or off-premises, such as on a cloud-based services platform. The benchmark-driven scheduler may identify the suitable implementation environment for each of the tasks of the workflow and instruct one or more environment schedulers to implement the tasks in their respective suitable environment. The suitable environment identified for each task may depend on one or more factors. For example, a specific prioritized goal may dynamically change the identified suitable environment. Further, resource availability within the environments and/or resource utilization of the environment by other workflows (e.g., current and/or historical) may impact the selected suitable environment.

In subsequent passes, the benchmark-driven scheduler may take into account performance analysis of the current execution and/or other factors, such as dynamic changes in resource availability within the environments when re-evaluating the tasks' suitable environments. These subsequent passes may result in adjustments to the implementation environment(s) used to implement particular tasks.

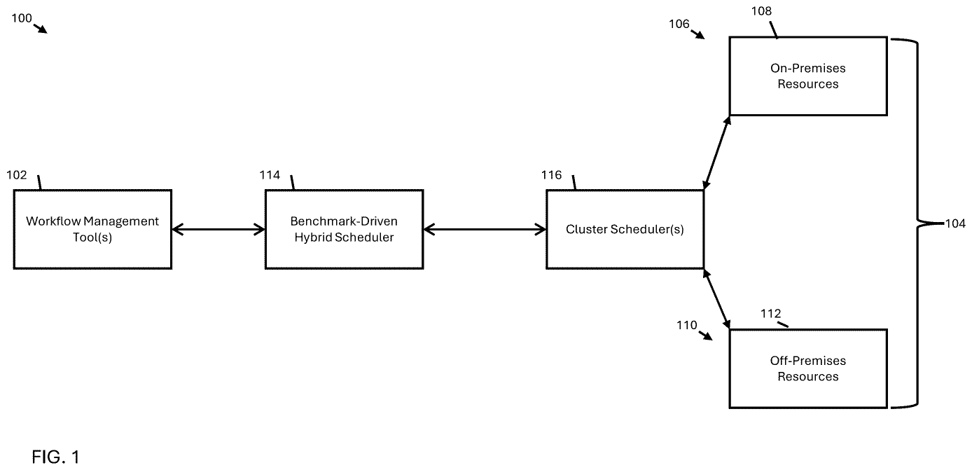

With this in mind, FIG. 1 is a schematic diagram, illustrating a system 100 that provides hybrid workflow, in accordance with aspects of the present disclosure. System 100 includes a workflow management tool 102 that manages the execution of workflows (a set of tasks or jobs ordered and connected, which may share data and results, to achieve completion of an overall task). The workflow management tool 102, in addition to defining and/or identifying the workflows, such as in a directed acyclic graph (DAG), is responsible for ensuring completion of all tasks in their respective orders to achieve the overall task.

System 100 may implement tasks in a hybrid implementation environment 104 that includes two or more different implementation environments. Here, for example, the hybrid implementation environment 104 includes an on-premises environment 106 that uses on-premises resources 108 and an off-premises environment 110 that uses off-premises resources 112. On-premises environment 106 may include, for example, an entity's data center utilizing entity-managed data center resources, while off-premises environment 110 may include a cloud computing environment, such as a serverless, virtual machine (VM) and/or container environment. As used herein, the term “serverless” refers to a computational paradigm, where the size of deployed programs is reduced to functions (for ease of deployment), and the management and execution process is performed by a platform provider and not by the developer. This paradigm facilitates the deployment of fast execution functions, improving scalability and reducing entity resource usage costs.

Workflow task execution may be assigned to a particular implementation environment (e.g., on-premises environment 106 and/or off-premises environment 110) of the hybrid implementation environment 104 by a benchmark-driven hybrid scheduler 114. The benchmark-driven hybrid scheduler 114 may assign particular implementation environments of the hybrid implementation environment 104 based upon relevant characteristics, such as characteristics of the workflow, the tasks, and/or implementation characteristics, such as characteristics of on-premises resources 108 and/or off-premises resources 112. Relevant characteristics may include, for example, different aspects such as a task's execution time, resource availability and/or usage, a task's data dependencies, data movements, and/or other factors. These characteristics may change over time (e.g., resource availability within a particular implementation environment may increase or decrease as tasks are added or removed). Thus, assignments may change based upon changes with respect to the relevant characteristics.

To assign tasks to particular implementation environments, the benchmark-driven hybrid scheduler 114 may receive an indication of workflow tasks for implementation from the workflow management tool 102. For example, the benchmark-driven hybrid scheduler 114 may receive a Directed Acyclic Graph (DAG), which is a data-structure representing the workflow and its associated tasks. The benchmark-driven hybrid scheduler 114 assigns the received workflow tasks between the different implementation environments of the hybrid implementation environment 104 based upon the relevant characteristics.

For example, the benchmark-driven hybrid scheduler 114 may perform offloading, deploying at least a part of a computation (e.g., a portion of workflow tasks) to the off-premises environment 110 (e.g., a cloud environment) from on-premises environment 106. This act may save local resources for computational tasks that may need to be executed locally. If there are sufficient on-premises resources 108 to complete all workflow tasks in a manner that achieves a desired goal, in some cases, the benchmark-driven hybrid scheduler 114 may default to assigning workflow tasks to the on-premises environment 106. When there are not enough on-premises resources 108 and/or implementation of all tasks via the on-premises resources would not achieve a desired goal, the benchmark-driven hybrid scheduler 114 may assign implementation all or a portion of the tasks to the off-premises environment 110 using off-premises resources 112.

Based upon the assignments, the benchmark-driven hybrid scheduler 114 may instruct one or more cluster scheduler(s) 116 to implement the workflow tasks in their assigned implementation environment. The cluster scheduler(s) 116 may then submit the workflow tasks for implementation in their assigned implementation environment.

The relevant characteristics may change over time. Accordingly, the benchmark-driven hybrid scheduler may periodically poll the workflow management tool(s) 102 and/or the cluster scheduler(s) 116 for updates regarding the relevant characteristics. For example, the workflow management tool(s) may provide periodic updates as to how many jobs and/or tasks are currently being implemented and/or are expected to be implemented based upon historic implementation, which may impact assignments of workflow tasks to a particular implementation environment. The cluster scheduler(s) may provide updated performance and/or availability metrics, which may change over time and may impact assignments to a particular implementation environment. As assignment decisions are changed (e.g., based upon variances in the relevant factors), the benchmark-driven hybrid scheduler 114 may update the assignments and provide the updated assignments to the cluster scheduler(s) 116, causing the cluster scheduler(s) 116 to transition the workflow tasks with changed assignments to the newly assigned implementation environment.

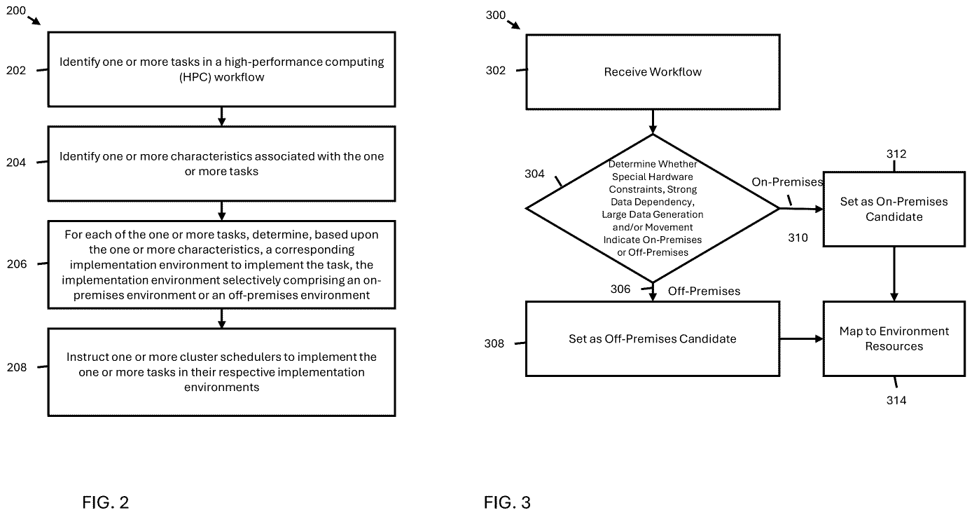

FIG. 2 is a flowchart, illustrating a process 200 for identifying and assigning implementation environments for task implementation across a hybrid implementation environment, in accordance with aspects of the present disclosure.

The process begins with identifying one or more tasks in a high-performance computing (HPC) workflow (block 202). For example, the one or more tasks may be identified from an electronic representation of the workflow, such as a directed acyclic graph (DAG) that provides an indication of the one or more tasks via one or more nodes provided in the DAG. Upon receiving the DAG, the DAG may be traversed to identify the one or more tasks of the HPC workflow at each observance of a node in the DAG.

Process 200 includes identifying one or more characteristics associated with the one or more tasks (block 204). The characteristics may include relevant characteristics for identifying a particular implementation environment that a task's implementation is to be assigned to. The relevant characteristics may be any implementation characteristics that may indicate a particular implementation environment being preferred over another implementation environment. For example, resource utilization and/or availability may be used to bias task assignment toward an implementation environment with lower resource utilization and/or higher resource availability. Further, task characteristics may indicate more suitability in one implementation environment over another implementation environment. For example, when a task will be implemented numerous times, it may be beneficial to offload to an off-premises implementation environment that is capable of running many invocations of a task in parallel. The relevant characteristics may be obtained from the DAG and/or one or more data providers, such as resource monitoring tools of the implementation environments, which provide characteristics associated with implementation of the workflow.

For example, the one or more characteristics may include implementation environment characteristics, such as resource availability within the particular implementation environment(s) and/or whether a task is already implemented within a particular environment. Resource availability information may be tracked within a respective environment (e.g., via a resource monitoring tool) and updates may be received periodically for use in assignment of implementation environments. The resource availability for a given workflow may be identified as an amount of resources allocated for workflow implementation minus an amount of the amount of these resources that are currently being used (e.g., as tracked by the resource monitoring tool).

In some cases, when resource availability is limited within a first implementation environment, this may bias task implementation to a different environment. For example, task implementation may default to on-premises implementation environment. However, when on-premises resources are limited and/or constrained, some task implementation may be biased toward offloading to an off-premises environment to free up local (on-premises) resources. In cases where a task or similar task is already implemented in a particular environment some overhead with regard to this task may be reduced. For example, if a task and/or similar task is already implemented in an off-premises implementation environment, the off-premises implementation environment is already pre-warmed for the task, as the environment for running the task has already been allocated. This reduces an amount of overhead in offloading to the off-premises implementation environment. Accordingly, in some cases, when a task or similar task is already implemented in a particular implementation environment, this may bias the task toward that implementation environment.

The one or more characteristics may also include characteristics of the workflow and/or the tasks within the workflow. These characteristics may be obtained by analysis of an electronic representation (e.g., the DAG) of the workflow and corresponding tasks. The electronic representation (e.g., the DAG) may be traversed to identify the characteristics of the nodes and, thus, their corresponding tasks. For example, a number of implementations/invocations of the tasks expected to be run may influence the environment. If the number of implementations/invocations exceeds and/or is expected to exceed a scalability threshold, this may bias the task toward offloading to the off-premises environment, as the off-premises environment may be better equipped for scalability of the task. The number of implementations may be identified by traversing the DAG to identify a number of nodes associated with a particular task. The number of nodes associated with a particular task indicates the number of implementations planned for that task.

Additionally, data dependencies and/or movement between tasks may bias implementation assignment. Tasks with significant data dependencies (e.g., having a number of incoming data inputs and/or an amount of incoming data exceeding an input threshold) and/or associated with large data movement (e.g., a relatively large amount of incoming and/or outgoing data) may be biased towards a particular implementation environment. For example, the tasks may be assigned to an implementation environment better equipped to handle the data dependencies and/or data movement, such as an on-premises environment that is better equipped to handle large data dependencies and/or a common implementation environment of the tasks that that task is dependent on (e.g., receives input from) and/or that the task provides output to.

The data dependencies of a task may be identified by traversing the electronic representation (e.g., the DAG) of the workflow. Specifically, as the electronic representation of the workflow is traversed, at each node, the inputs of the node may be identified. The number of inputs at each node indicates the number of tasks that the task represented by the node is dependent on. Further, a number of outputs of the node may be identified, the number of outputs indicating a number of tasks that are dependent upon the task represented by the node.

The amount of data movement associated with a task (e.g., data movement into the task and/or out of the task) may be identified from the data dependencies identified from the electronic representation of the workflow. For example, the electronic representation of the workflow may indicate an amount of data that will be provided at each input to and output from a node representing a task. Thus, the data movement into the task represented by the node may be identified by adding the amount of data of each input of the node, resulting in the task's input data movement. Further, the data movement out of the task represented by the node may be identified by adding the amount of data of each output of the node, resulting in the task's output data movement.

In some cases, the one or more characteristics may include the task's size, which may be identified by identifying an amount of executable code (e.g., in one or more implementations) associated with the task. When the task size of a task exceeds a threshold task size, for example, this may indicate to bias the task towards an off-premises environment, which may provide better processing of such tasks (e.g., through load balancing and/or parallelism). Otherwise, when the task size of the task does not exceed the threshold, this may indicate to bias the task toward the on-premises environment, which may be able to efficiently handle the relatively less complex implementation.

For each of the one or more tasks, a corresponding implementation environment to implement the task is determined, based upon the one or more characteristics (block 206). To do this, in some cases, each of the relevant characteristics may be weighed and factored into an implementation environment score that indicates whether to assign the task to an off-premises environment or an on-premises environment. In some cases, certain of the relevant characteristics may be determinant, meaning that if the determinant characteristic is observed, a particular implementation environment is assigned, despite other of the relevant characteristics biasing toward a different implementation environment.

At block 208, one or more cluster schedulers are instructed to implement the one or more tasks in their respective implementation environments. For example, a first electronic implementation request may be provided to an off-premises cluster scheduler indicating the tasks associated with an off-premises implementation environment and a second electronic implementation request may be provided to an on-premises cluster scheduler indicating the tasks associated with an on-premises implementation environment. Thus, the assigned tasks may be implemented in their assigned implementation environment of the hybrid implementation environment.

FIG. 3 is a flowchart, illustrating a process 300 for identifying and assigning implementation environments for task implementation across a hybrid implementation environment including an on-premises implementation environment and an off-premises implementation environment, in accordance with aspects of the present disclosure.

At block 302, process 300 includes receiving a workflow. The workflow may be received in the form of a particular data structure representing the workflow and its associated tasks, such as a directed acyclic graph (DAG) with nodes representing tasks of the workflow and links/arrows between the nodes indicating the dataflow and/or dependencies between the tasks of the workflow.

To identify an implementation environment to suggest relevant characteristics are identified. Thus, a determination is made as to whether there are any special hardware constraints, strong data dependencies between tasks, and/or large data generation and/movement between the tasks indicates on-premises and/or off-premises implementation (decision block 304). For example, special hardware constraints may exist with respect to a task, such as a constraint that a particular type of hardware and/or a particular amount of hardware resources be used for implementing a particular task. In such a case, the implementation environment may be biased to an implementation environment that is able to satisfy the special hardware constraint.

If there is a strong data dependency between tasks, this too may indicate that a particular implementation environment should be used. In some cases, when there are strong data dependencies between tasks, the task may be biased toward an on-premises implementation environment by default. In some cases, the task may be biased toward a common implementation environment with the dependency tasks. In this manner, cross-movement between implementation environments may be reduced.

Large data generation and/or data movement between tasks may also be used to bias toward (or away from) a particular implementation environment. For example, when there is a large amount of data generated by a task and/or a large amount of data movement to and/or from a task, the task may be biased toward the on-premises implementation environment, which may be more effective at handling the large data generation (e.g., with reduced costs).

If the relevant characteristics indicate to implement the task off-premises, as indicated by arrow 306, the task is set as an off-premises candidate assignment (block 308). If the relevant characteristics indicate to implement the task on-premises, as indicated by arrow 310, the task is set as an off-premises candidate assignment (block 312).

Using the assignments, the tasks are mapped to corresponding implementation environment resources (block 314). Specifically, an indication of the task and its indicated candidate implementation environment may be stored in a datastore, such as a datastore communicatively coupled to the benchmark-driven hybrid scheduler 114 of FIG. 1 and/or the cluster scheduler(s) 116 of FIG. 1. In some cases, this mapping may include associating a task identifier of each of the tasks with an implementation environment identifier within the datastore. Thus, off-premises candidate tasks are assigned to an off-premises implementation environment and on-premises candidate tasks are assigned to on-premises implementation environment, enabling implementation of the workflow tasks in their assigned implementation environments (e.g., via cluster scheduling via the cluster scheduler(s) 116 of FIG. 1).

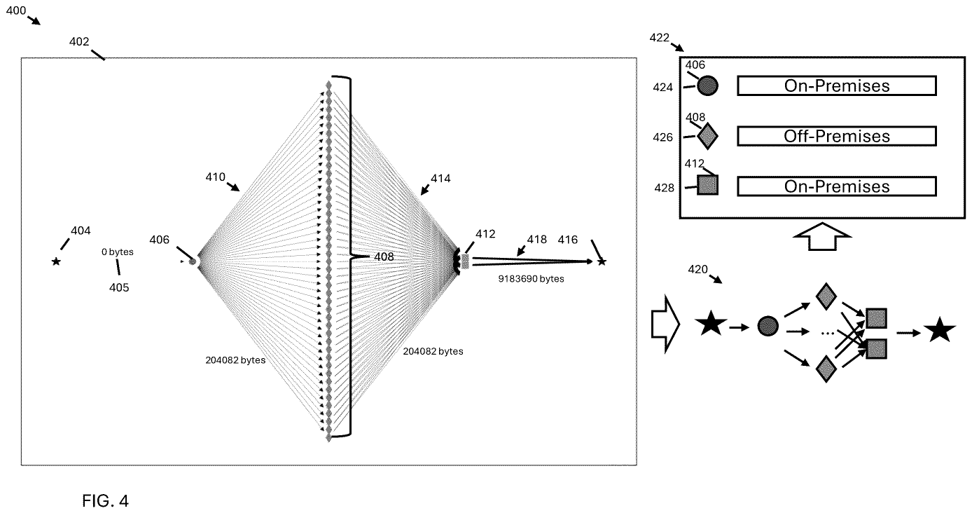

FIG. 4 is a schematic diagram, illustrating an example 400 of assignment of tasks in a hybrid implementation environment, in accordance with aspects of the present disclosure. The DAG 402 illustrates a representation of a workflow to be implemented in the hybrid implementation environment. The star node 404 indicates a starting task. Arrow 405 illustrates a dependency of a first task represented by circle node 406 on the starting task (represented by star node 404). Many implementations of a second task (illustrated by diamond nodes 408) are run in parallel, as illustrated by the placement of the diamond nodes 408. Further, these implementations of the second task are all dependent on a single task (the first task represented by circle node 406), as indicated by arrows 410. A third task represented by square nodes 412 is implemented twice. Each of these implementations includes a dependency on each of the many implementations of the second task, as indicated by the arrows 414 flowing from the diamond nodes 408 to the square nodes 412. Star node 416 represents the ending task. The ending task is dependent on both of the implementations of the third node, as indicated by arrows 418 flowing from the square nodes 412 to the star node 416.

To identify an implementation environment assignment for each of the tasks of the DAG 402, the DAG 402 may be transformed, such as by flattening the DAG 402 into a flattened representation (e.g., removing a z-axis of the workflow in the DAG 402, sequentially ordering the nodes based upon dependencies from starting task to ending task), as illustrated by flattened DAG representation 420. The flattened DAG representation 420 may be traversed to identify the relevant factors for assigning a particular implementation environment for the nodes.

Implementation environment assignments 422 may be generated based upon the relevant characteristics. For example, here, the first task represented by circle node 406 has only one implementation and only one data dependency (that does not move any data, as indicated by “0 bytes”). Because the number of implementations, amount of moved data to and/or from this task, and the data dependencies of this task are all below thresholds indicating candidacy for offload to an off-premises implementation environment, the first task may be assigned as an on-premises candidate, as indicated by assignment 424.

While the second tasks represented by diamond nodes 408 each only receive data from one of the first tasks with a limited amount of data movement (204082 bytes from one task each), the number of implementations of the second tasks is above a threshold number of implementations indicative of candidacy for offloading. Indeed, as may be appreciated, when implementing a relatively large number of a particular task the autoscaling capabilities of the off-premises implementation environment may be quite beneficial. Further, the second tasks each may have a relatively fine granularity (e.g., each using a relatively small amount of resources below a granularity threshold). Thus, as indicated by assignment 426, the second tasks associated with diamond nodes 408 are assigned to an off-premises implementation environment.

The third tasks associated with square nodes 412, have a number of implementations below a scalability threshold indicating to offload to an off-premises implementation environment. Further, there are strong data dependencies above a data dependency threshold, indicating to assign the on-premises implementation environment. Additionally, there is an amount of data movement in (204082 bytes times the number of second tasks) and data movement out (9183690 bytes) of the third tasks, each of which exceeds a data movement threshold. Based upon each of these relevant characteristics, as illustrated by assignment 428, the third task is assigned to the on-premises implementation environment. Based upon the assignments 422, the tasks may be implemented in their assigned implementation environments.

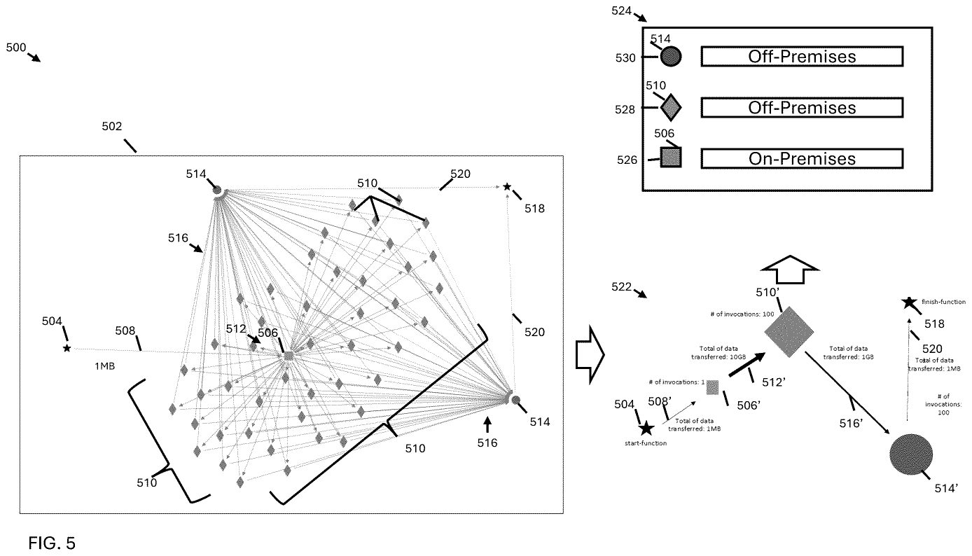

FIG. 5 is a schematic diagram, illustrating another example 500 of assignment of tasks in a hybrid implementation environment, in accordance with aspects of the present disclosure. The DAG 502 represents a workflow where a starting task represented by star node 504 provides 1 MB of data to a first task represented by square node 506, as illustrated by arrow 508 and “1 MB”. The first task provides 10 GB of data to 100 implementations of a second task represented by diamond nodes 510 and arrows 512 flowing from the square node 506 to the diamond nodes 510. The second task implementations provide a total of 1 GB to 100 implementations of a third task represented by circle nodes 514 and arrows 516 flowing from the diamond nodes 510 to the circle nodes 514. The third task implementations provide a total of 1 MB of data to an ending function represented by star node 518 and arrows 520.

A flattened representation 522 of the DAG 502 is generated and used to identify the relevant characteristics of the DAG 502 for generating an assignment 524 of an implementation environment for the workflow tasks. In the current example, the flattened representation 522 includes a single node for each task with a size of the node representing a number of implementations of the task that are performed. Further, the size of the arrows is adjusted to indicate an amount of data associated with a total flow represented by the arrow. For example, as illustrated, a relatively thin arrow 508′ is provided between the star node 504 representing the starting function and a relatively small square node 506′, indicating a relatively small amount of data movement (e.g., here, 1 MB), from the starting function to a relatively small number of implementations (e.g., here, 1) of the first function represented by the small square node 506′. A relatively thick arrow 512′ connects the small square node 506′ and a relatively large diamond node 510′, indicating a relatively large amount of total transferred data (e.g., here, 10 GB) between the implementations of the first task and a relatively large number of implementations (e.g., here, 100) of the second task. A relatively moderate arrow 516′ flows from the relatively large diamond node 510′ to a relatively large circle node 514′, indicating a moderate amount of data (e.g., here 1 GB) flowing from the invocations of the second task to a relatively large number of implementations (e.g., here, 100) of the third task. A relatively thin arrow 520′ flows for the relatively large circle node 514′ to the star node 518, indicating that a relatively small (e.g., here, 1 MB) of data flows from the implementations of the third task to the ending function.

Given the relatively small number of implementations of the first function and the large amount of data communicated out of the first function (e.g., here 10 GB) the assignment 526 of the first function is set to on-premises. Further, given the large amount of data flowing into the second function, the second function may not be a good candidate for off-premises. However, given the large number of implementations of the second function (e.g., here, 100) the autoscaling may make the second task a candidate for off-premises implementation environment. The assignment may, thus, be determined based upon the weighting of the relevant characteristics. For example, additional relevant characteristics may include an indication that there are limited local resources available, which may bias the assignment toward offloading the second task and, thus, assignment 528 is set to off-premises. In some cases, when there are conflicting relevant characteristics, assignment may be held in abeyance until the other tasks are assigned to an implementation environment. In this manner, a better understanding of how the tasks are allocated to the different implementation environments may be understood and accounted for in the assignment of tasks in a “gray area.” Given the moderate amount of data transferred into the third task (e.g., here, 1 GB), the relatively large number of implementations of the third task, and the relatively little amount of data flowing out of the third task (e.g., here, 1 MB), the assignment 530 corresponding to the third task is set to off-premises.

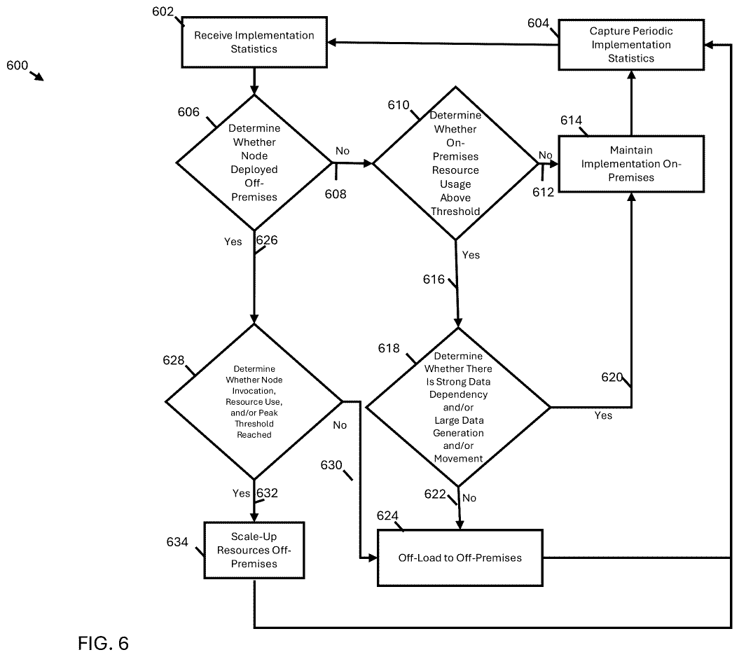

FIG. 6 is a flowchart, illustrating a process 600 for identifying and assigning implementation environments for task implementation across a hybrid implementation environment during workflow/job execution, in accordance with aspects of the present disclosure. Periodically, implementation environments assigned to particular tasks may change (e.g., because of changes in the relevant characteristics during job execution). Thus, it may be desirable to periodically change implementation environment assignments for tasks based upon updated relevant characteristics of the tasks and/or implementation environments.

To perform these changed assignments, process 600 begins with receiving implementation statistics (block 602) which are captured periodically during implementation of a workflow (block 604). The implementation statistics include resource availability, resource utilization, and/or other relevant characteristics useful to determine a proper implementation environment. The periodic interval may be a predetermined static time interval and/or may dynamically change to account for changes within the implementation environments. Relatively shorter intervals may result in assignment of implementation environments that more quickly react to changes (e.g., resource availability changes) within the implementation environments. Relatively longer intervals may reduce processing resource usage, by refreshing assignments less frequently. In some cases, the periodic interval may be dynamically adjusted on the fly, as certain implementation environment characteristics are observed. For example, as an implementation environment's resource availability falls, it may be desirable to dynamically re-assign implementation environments more quickly. Thus, upon falling below a resource availability threshold, the periodic interval, in some cases, may be reduced, resulting in faster re-assignment of implementation environments.

For each node/task in a workflow, at decision block 606, a determination is made as to whether the node/task is deployed off-premises. To do this, a datastore storing the tasks and their assigned implementation environments may be accessed to retrieve the tasks' implementation environment assignments.

For each task, if the task is not deployed off-premises, this indicates that the node/task is implemented on-premises and, as illustrated by arrow 608, a subsequent determination of whether on-premises resource usage is above a threshold is performed (decision block 610). The threshold may provide an indication of an amount of resources that, when reached by usage metrics (e.g., provided by a resource usage tracking tool within the implementation environment), indicates to offload at least a portion of tasks of a workflow (e.g., to maintain resource availability in the on-premises implementation environment). In some cases, an available resource threshold may indicate a minimum amount of available resources on-premises that should be maintained. Thus, when the available amount of resources (e.g., as indicated by the resource availability tracking tool within the implementation environment that tracks the available resources within the implementation environment) is below this threshold, this may also indicate to offload at least a portion of the workflow tasks.

Process 600 is locally-biased, preferring on-premises implementation if there are enough on-premises resources to support the workflow implementation. Accordingly, if the on-premises resource usage is not above a threshold, as indicated by arrow 612, the task implementation may be maintained on-premises (block 614). However, when the on-premises usage is above a threshold, as indicated by arrow 616, a determination is made as to whether the task is a good candidate for offloading to off-premises implementation environment. Specifically, a determination is made as to whether the task has a strong data dependency and/or large data generation and/or a large amount of data movement in and/or out of the task (decision block 618). As mentioned above, the data dependency of each task may be identified by traversing the electronic representation (e.g., the DAG) of the workflow and identifying nodes providing data into and out of a node representing the task. The number of nodes providing data into the task's node represents the task's data dependency and the number of nodes connected to an output of the task's node represents the number of tasks dependent on the node. The task's data dependency and/or the number of tasks dependent on the tasks are compared to data dependency threshold indicative of a data dependency thresholds permitted by off-premises implementation. When the task's data dependency and/or number of tasks dependent on the tasks breach the data dependency threshold, it may be determined that the task has a strong data dependency.

The amount of data movement associated with a task (e.g., data movement into the task and/or out of the task) may be identified from input and/or output metrics associated with a tasks, such as the data dependencies identified from the electronic representation of the workflow. For example, the electronic representation of the workflow may indicate an amount of data that will be provided at each input to and output from a node representing a task. Thus, the data movement into the task represented by the node may be identified by adding the amount of data of each input of the node, resulting in the task's input data movement. Further, the data generation and/or data movement out of the task represented by the node may be identified by adding the amount of data of each output of the node, resulting in the task's output data movement. When the task's data movement exceeds a data movement threshold, the task may be determined to have a large data movement. Further, when the task's generated data exceeds a data generation threshold, the task may be determined to have a large data generation.

A strong data dependency, large data generation, and/or large data movement may be identified when breaching the If the task has a strong data dependency and/or large data generation and/or a large amount of data movement in and/or out of the task, as indicated by arrow 620, the task is set as a candidate for on-premises implementation and, thus, the on-premises implementation is maintained (block 614).

However, when there is not a strong data dependency and/or large data generation and/or large data movement associated with the task, as indicated by arrow 622, the task is set as a candidate for offloading to off-premises implementation and, thus, the task is offloaded to the off-premises implementation environment (block 624).

Returning to decision block 606, when the node/task is already deployed off-premises, as indicated by arrow 626, a determination as to whether off-premises implementation environment changes should be made based upon relevant characteristics of the implementation. Specifically, a determination may be made as to whether: a node invocation threshold (number of implementation/invocations of a particular task and/or number of implemented/invoked tasks) exceeds a threshold, an off-premises resource usage threshold is breached, and/or a peak threshold is reached (decision block 628).

The number of nodes of a particular task indicated in the DAG may indicate the number of nodes invoked by the workflow implementation. This number of nodes is compared to the node invocation threshold to determine whether the node invocation is reached. If so, this may indicate that additional off-premises resources should be requested.

The resource use of the off-premises implementation environment may be provided by the platform the off-premises implementation environment, via provision of one or more electronic indications of current resource use in the off-premises environment. The received current resource use is compared with a resource use threshold to identify whether the resource use threshold is reached. If so, this may indicate that additional off-premises resources should be requested.

The peak resource use of the off-premises implementation environment may indicate a maximum use of resources during implementation of the workflow. This value may be identified by finding the maximum resource use of the resource usage provided by the platform the off-premises implementation environment over the span of the workflow implementation. The peak resource use is compared with a peak threshold indicative of a ceiling of resource use that when reached may indicate that additional off-premises resources should be requested.

If these thresholds are not breached, as indicated by arrow 630, the task may remain offloaded to the off-premises implementation environment (block 624). However, when one or more of the thresholds is breached, this may indicate that the current allocation of resources used to implement the cloud-based features may not be enough to efficiently complete the tasks. Accordingly, the off-premises resources may be scaled up, by requesting additional resources from the off-premises platform (block 634).

However the task assignments are changed and/or retained, the implementation statistics are periodically captured (block 604) and used to further determine dynamic implementation environment assignments for the tasks.

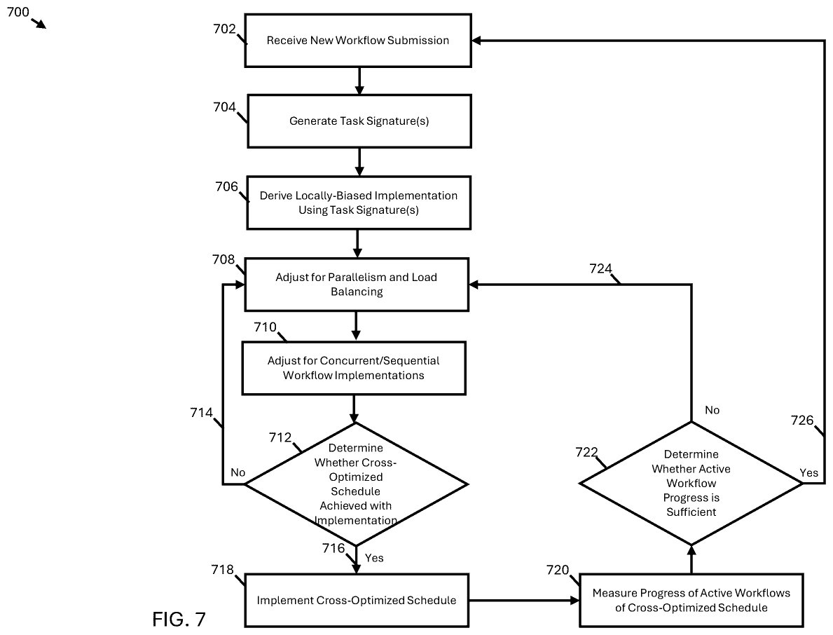

FIG. 7 is a flowchart, illustrating a process 700 for identifying and assigning implementation environments for task implementation, accounting for multiple running workflows/jobs within the hybrid implementation environment, in accordance with aspects of the present disclosure. The process 700 begins with receiving a new workflow submission (block 702).

At block 704, task signature(s) are generated for each task of the new workflow submission. The task signature(s) include benchmarking resource utilization for the task(s) both for both off-premises resource utilization and on-premises resource utilization. In one example, the signature may include the following:

$$sign = [ \begin{matrix}{CPU}_{FaaS} & {Memory}_{FaaS} & {Comm}_{FaaS} \\ {CPU}_{app} & {Memory}_{app} & {Comm}_{app}\end{matrix} ]$$

As illustrated in the above signature, the signature may include benchmarking results for CPU utilization, memory utilization, and communication metrics on-premises and off-premises. Thus, these metrics may be used to identify expected resource utilization both on-premises and off-premises.

At block 706, a locally-biased implementation is derived using the task signature(s). The locally-biased implementation is derived by defaulting assignment of tasks to an on-premises implementation environment (e.g., setting the associated implementation environment for a given task identifier to the on-premises implementation environment identifier in a datastore storing the assignments), offloading to an off-premises implementation environment (e.g., setting the associated implementation environment for a given task identifier to the off-premises implementation environment identifier in a datastore storing the assignments) when on-premises resource availability is constrained. The on-premises resource availability may be determined based upon subtracting the benchmarking values of the tasks that are provided in the signatures from an overall amount of available resources. Upon reaching a resource constraint threshold, the on-premises resource availability may be identified as constrained, resulting in offloading of tasks.

At block 708, adjustments are made to the locally-biased implementation for parallelism and load balancing. For example, tasks that are implemented a number of times may be offloaded to the off-premises implementation environment, where autoscaling features may provide improved implementation. As mentioned above, the number of implementations of a particular task may be identified by traversing the electronic representation of the workflow (e.g., the DAG) to identify a number of nodes associated with the particular task. The number of nodes associated with a particular task indicates the number of implementations planned for that task. When this number exceeds a threshold, this may indicate a good candidate task for taking advantage of parallelism and load balancing benefits of the off-premises implementation environment. Accordingly, the assignments of such tasks are set to the off-premises implementation environment (e.g., setting the associated implementation environment for a given task identifier to the off-premises implementation environment identifier in a datastore storing the assignments).

At block 710, adjustments are made for concurrent and/or sequential workflow implementations. For example, the predicted resource utilization of other concurrent workflows running and/or expected to run (e.g., based upon historical workflow implementation) indicated in these tasks' signatures may be applied to the resource availability of the on-premises implementation environment to identify expected resource availability upon implementation of the other workflows. This expected resource availability may be used to identify further offloading optimizations to implement. For example, if the expected resource availability is relatively low, a relatively higher level of offloading may be performed.

A determination is made as to whether a cross-optimized schedule is achieved with the adjusted implementation (decision block 712). For example, a determination may be made to identify whether the relevant characteristics for implementation environment for each of the active workflows offloads and retains locally (in the on-premises implementation environment) the workflow tasks within optimization parameters set for the cross-workflow implementation. For example, a cross-optimized schedule may be achieved when each of the workflows being implemented would result in staying within a desired range of on-premises resource use and/or off-premises resource use.

If a cross-optimized schedule is not achieved, as indicated by arrow 714, additional adjustments are made for parallelism and load balancing (block 708) and concurrent and/or sequential workflow implementations (block 710) until a cross-optimized schedule is achieved.

Once the cross-optimized schedule is achieved (e.g., all active workflows can be implemented within the optimization constraints, such as the resource use thresholds, the resource availability thresholds, and/or the peak usage threshold), as indicated by arrow 716, the cross-optimized schedule is implemented (block 718). To do this, an electronic indication of the on-premises tasks is sent to an on-premises scheduler for implementation and an electronic indication of the off-premises tasks are sent to an off-premises scheduler for implementation.

At block 720, progress of the active workflows of the cross-optimized schedule is measured. A determination is made as to whether the active workflow progress is sufficient (decision block 722). For example, certain progression threshold, such as timing constraints (e.g., how long the workflow may run before completion and/or a progress rate) may be allotted for the workflow implementation. When the workflow implementation meets these progression thresholds, the progress may be identified as sufficient.

If the workflow implementation does not meet the progression thresholds and, thus, is not sufficient, as illustrated by arrow 724, additional adjustments are made for parallelism and load balancing (block 708) and concurrent and/or sequential workflow implementations (block 710) until a new cross-optimized schedule is achieved. If the active workflow progress is sufficient, as indicated by arrow 726, the process 700 continues looking for additional new workflow submissions (block 702).

As may be appreciated, the current techniques provide significant value. Specifically, the current techniques provide dynamically adjustable implementation environment assignments for workflow tasks customized to the particular relevant characteristics associated with the workflow. Further, as new workflows are introduced, cross-optimization may be achieved, maximizing on-premises and off-premises resources to achieve implementation goals.

While only certain features of the present disclosure have been illustrated and described herein, many modifications and changes will occur to those skilled in the art. It is, therefore, to be understood that the appended claims are intended to cover all such modifications and changes as fall within the true spirit of the present disclosure.

1. A computer-implemented method, comprising:
identifying one or more tasks in a high-performance computing (HPC) workflow;
identifying one or more characteristics associated with the one or more tasks;
for each of the one or more tasks, determining, based upon the one or more characteristics, a corresponding implementation environment to implement the task, the corresponding implementation environment selectively comprising an on-premises environment or an off-premises environment; and
instructing one or more cluster schedulers to implement the one or more tasks in their respective implementation environments.

2. The computer-implemented method of claim 1, wherein a first corresponding implementation environment for a first subset of the one or more tasks comprises the off-premises environment.

3. The computer-implemented method of claim 2, wherein a second corresponding implementation environment for a second subset of the one or more tasks comprises the on-premises environment.

4. The computer-implemented method of claim 1, comprising:
receiving a directed acyclic graph (DAG) representing the HPC workflow;
identifying one or more nodes of the DAG as the one or more tasks in the HPC workflow; and
identifying the one or more characteristics based upon characteristics of the one or more nodes of the DAG.

5. The computer-implemented method of claim 4, comprising:
flattening the DAG; and
deriving the one or more characteristics by traversing nodes of the flattened DAG and capturing aggregated metrics associated with the traversed nodes.

6. The computer-implemented method of claim 1, comprising:
for each of the one or more tasks, determining, based upon the one or more characteristics, the corresponding implementation environment to implement the task, by biasing the corresponding implementation environment to either the on-premises environment or the off-premises environment based upon the one or more characteristics.

7. The computer-implemented method of claim 6, wherein the one or more characteristics comprise a task granularity indicative of a task size of a respective task; and
the computer-implemented method comprises:
identifying whether the task size of the respective task exceeds a threshold task size; and
when the task size does not exceed the threshold task size, biasing the corresponding implementation environment for the respective task to the on-premises environment; and
when the task size exceeds the threshold task size, biasing the corresponding implementation environment for the respective task to the off-premises environment.

8. The computer-implemented method of claim 6, wherein the one or more characteristics comprise at least one of: an input metric of a respective task quantifying an amount of incoming data or an output metric of the respective task indicating an amount of outgoing data; and
the computer-implemented method comprises:
identifying at least one of: whether the input metric of the respective task exceeds an input threshold value or the output metric of the respective task exceeds an output threshold value; and
when at least one of: the input metric of the respective task does not exceed the input threshold value or the output metric of the respective task does not exceed the output threshold value, biasing the corresponding implementation environment of the respective task to the on-premises environment; and
when at least one of: the input metric of the respective task exceeds the input threshold value or the output metric of the respective task exceeds the output threshold value, biasing the corresponding implementation environment of the respective task to the off-premises environment.

9. The computer-implemented method of claim 6, wherein the one or more characteristics comprise an indication of a number of times a respective task will be invoked; and
the computer-implemented method comprises:
identifying whether the number of times the respective task will be invoked exceeds a threshold number of times; and
when the number of times the respective task will be invoked does not exceed the threshold number of times, biasing the corresponding implementation environment for the respective task to the on-premises environment; and
when the number of times the respective task will be invoked exceeds the threshold number of times, biasing the corresponding implementation environment for the respective task to the off-premises environment.

10. The computer-implemented method of claim 1, comprising:
identifying a resource usage metric indicating resource usage by other HPC workflows for at least one of the on-premises environment or the off-premises environment, by: identifying at least one of:
one or more concurrently implemented HPC workflows and associated resource usage; or
a historical number of HPC workflows implemented concurrently and associated resource usage.

11. The computer-implemented method of claim 1, comprising:
for each of the one or more tasks, re-determining the corresponding implementation environment after implementation of the one or more tasks, based upon a current resource availability in both the on-premises environment and the off-premises environment.

12. The computer-implemented method of claim 10, comprising:
generating a respective signature for each of the one or more tasks, the respective signature comprising benchmarked resource utilization for the task in both the on-premises environment and the off-premises environment; and
re-determining the corresponding implementation environment after implementation of the one or more tasks based on the respective signature for each of the one or more tasks.

13. A hybrid scheduler, comprising:
memory; and
a processor, configured to perform dynamic implementation environment assignments, by:
receiving implementation statistics regarding tasks of a workflow implemented in a hybrid implementation environment;
for an off-premises subset of the tasks that are deployed off-premises:
determining, from the implementation statistics, whether a node invocation threshold, a resource use threshold, or a peak implementation threshold are breached by the off-premises subset;
when the node invocation threshold, the resource use threshold, or the peak implementation threshold are breached, requesting a scale-up of off-premises resources; and
when the node invocation threshold, the resource use threshold, and the peak implementation threshold are not breached, maintaining off-premises implementation of the off-premises subset of the tasks;
for an on-premises subset of the tasks that are deployed on-premises:
determining, from the implementation statistics, whether on-premises resource usage is above a resource usage threshold;
when the on-premises resource usage is not above a resource usage threshold, maintaining implementation of the on-premises subset of the tasks;
when the on-premises resource usage is above the resource usage threshold, identify, from the on-premises subset of the tasks, one or more candidate tasks to offload for off-premises implementation; and
offload the one or more candidate tasks for off-premises implementation.

14. The hybrid scheduler of claim 13, wherein the processor is configured to re-perform the dynamic implementation environment assignments periodically based upon periodically captured implementation statistics.

15. The hybrid scheduler of claim 13, wherein the processor is configured to identify the one or more candidate tasks based upon at least one of:
the one or more candidate tasks having a data dependency below a threshold level of data dependency from other tasks in the workflow;
the one or more candidate tasks generating less data than a data generation threshold; or
the one or more candidate tasks having less incoming data from other tasks and less outgoing data to other tasks than one or more data movement thresholds.

16. The hybrid scheduler of claim 13, wherein the processor is configured to perform an initial implementation environment assignment, by:
identifying the tasks of the workflow;
identifying one or more characteristics associated with the tasks; and
for each of the tasks, determining, based upon the one or more characteristics, a corresponding implementation environment to implement the task, the corresponding implementation environment selectively comprising an on-premises environment or an off-premises environment.

17. The hybrid scheduler of claim 13, wherein the processor is configured to perform dynamic implementation environment assignments, by instructing one or more cluster schedulers to implement the tasks in their respective implementation environments.

18. A non-transitory, computer-readable medium comprising computer readable instructions that, when executed by one or more processors of one or more computers, cause the one or more computers to:
identify tasks of a workflow to be implemented;
perform an implementation environment assignment in a hybrid implementation environment, by:
identifying the tasks of the workflow;
identifying one or more characteristics associated with the tasks; and
for each of the tasks, determining, based upon the one or more characteristics, a corresponding implementation environment to implement the task, the corresponding implementation environment selectively comprising an on-premises environment or an off-premises environment; and
periodically, re-perform the implementation environment assignment based upon updates to the one or more characteristics associated with the tasks and implementation statistics of the tasks.

19. The non-transitory, computer-readable medium of claim 18, wherein the implementation statistics comprise at least one of: on-premises resource usage, on-premises resource availability, off-premises resource usage, or off-premises resource availability.

20. The non-transitory, computer-readable medium of claim 18 comprising computer readable instructions that, when executed by one or more processors of one or more computers, cause the one or more computers to:
adjust an assigned implementation environment of at least a portion of the tasks based upon other workflows implemented in the hybrid implementation environment.
